(19) United States
(12) Patent Application Publication
(10) Pub. No.: US 2026/0223041 A1
(43) Pub. Date: Jul. 30, 2026

(54) INFORMATION SENDING METHOD AND APPARATUS, INFORMATION RECEIVING METHOD AND APPARATUS, AND COMMUNICATION APPARATUS AND STORAGE MEDIUM

(71) Applicant: Beijing Xiaomi Mobile Software Co., Ltd., Beijing (CN)

(72) Inventors: Xiaolong LI, Beijing (CN); Qin MU, Beijing (CN)

(21) Appl. No.: 19/142,703

(22) PCT Filed: Dec. 29, 2022
(86) PCT No.: PCT/CN2022/143610

§ 371 Date: Jun. 24, 2025

(51) Int. Cl. H04W 64/00; H04L 5/00; H04L 41/16; H04W 8/22

(52) U.S. Cl. CPC H04W 64/00; H04L 5/0051; H04L 41/16; H04W 8/22

(57) ABSTRACT

An information sending method is performed by a communication apparatus, and includes: sending first indication information to a network element in a core network, wherein the first indication information indicates information of an artificial intelligence (AI) model used by the communication apparatus to determine location-related information of a terminal.

### CROSS-REFERENCE TO RELATED APPLICATIONS

This application is a US national stage of International Application No. PCT/CN2022/143610, filed on Dec. 29, 2022, the content of which is hereby incorporated by reference in its entirety.

### TECHNICAL FIELD

The present disclosure relates to the field of communication technologies, and in particular, to an information sending method, an information receiving method, an information sending apparatus, an information receiving apparatus, an information interaction system, a communication apparatus, and a computer-readable storage medium.

### BACKGROUND

With development of positioning technologies, an artificial intelligence (AI) model is being applied to a mobile network to determine a location of a terminal in the mobile network. For each positioning application scenario, a corresponding artificial intelligence model may be applied to determine the location.

### SUMMARY

According to a first aspect of the embodiments of the present disclosure, an information sending method is provided, performed by a communication apparatus, including:
sending first indication information to a network element of a core network, where the first indication information indicates information of an artificial intelligence model used by the communication apparatus to determine location-related information of a terminal.

According to a second aspect of the embodiments of the present disclosure, an information receiving method is provided, performed by a network element of a core network, including: receiving first indication information sent by a communication apparatus, where the first indication information indicates information of an artificial intelligence model used by the communication apparatus to determine location-related information of a terminal.

According to a third aspect of the embodiments of the present disclosure, an information sending apparatus is provided, including: a communication module, configured to send first indication information to a network element of a core network, where the first indication information indicates information of an artificial intelligence model used by a communication apparatus to determine location-related information of a terminal.

According to a fourth aspect of the embodiments of the present disclosure, an information receiving apparatus is provided, including: a communication module, configured to receive first indication information sent by a communication apparatus, where the first indication information indicates information of an artificial intelligence model used by the communication apparatus to determine location-related information of a terminal.

According to a fifth aspect of the embodiments of the present disclosure, an information transceiving system is provided, including a communication apparatus and a network element of a core network, where the communication apparatus is configured to implement the above information sending method, and the network element is configured to implement the above information receiving method.

According to a sixth aspect of the embodiments of the present disclosure, a communication apparatus is provided, including: a processor; and a memory for storing a computer program, where when the computer program is executed by the processor, the above information receiving method is implemented.

According to a seventh aspect of the embodiments of the present disclosure, a communication apparatus is provided, including: a processor; and a memory for storing a computer program, where when the computer program is executed by the processor, the above information sending method is implemented.

According to an eighth aspect of the embodiments of the present disclosure, a computer-readable storage medium is provided, configured to store a computer program, where when the computer program is executed by a processor, the above information sending method is implemented.

According to a ninth aspect of the embodiments of the present disclosure, a computer-readable storage medium is provided, configured to store a computer program, where when the computer program is executed by a processor, the above information receiving method is implemented.

According to the embodiments of the present disclosure, a communication apparatus can send first indication information to a network element of a core network, and the first indication information indicates an artificial intelligence model used by the communication apparatus to determine location-related information of a terminal, such that the network element of the core network can learn, in a timely manner, about the artificial intelligence model used by the communication apparatus, and thus can perform proper management on the artificial intelligence model.

### BRIEF DESCRIPTION OF DRAWINGS

The accompanying drawings of the present disclosure will be briefly described below; it is obvious that the drawings in the following description are only example embodiments of the present disclosure.

FIG. 1 is a schematic flowchart of an information sending method according to an embodiment of the present disclosure.

FIG. 2 is a schematic flowchart of another information sending method according to an embodiment of the present disclosure.

FIG. 3 is a schematic flowchart of another information sending method according to an embodiment of the present disclosure.

FIG. 4 is a schematic flowchart of another information sending method according to an embodiment of the present disclosure.

FIG. 5 is a schematic flowchart of another information sending method according to an embodiment of the present disclosure.

FIG. 6 is a schematic flowchart of another information sending method according to an embodiment of the present disclosure.

FIG. 7 is a schematic flowchart of an information receiving method according to an embodiment of the present disclosure.

FIG. 8A is a schematic diagram of interaction between a terminal and a network element according to an embodiment of the present disclosure.

FIG. 8B is a schematic diagram of interaction between a base station and a network element according to an embodiment of the present disclosure.

FIG. 9 is a schematic block diagram of an information sending apparatus according to an embodiment of the present disclosure.

FIG. 10 is a schematic block diagram of an information receiving apparatus according to an embodiment of the present disclosure.

FIG. 11 is a schematic block diagram of a device for receiving information according to an embodiment of the present disclosure.

FIG. 12 is a schematic block diagram of a device for receiving information according to an embodiment of the present disclosure.

### DETAILED DESCRIPTION

The technical solutions in the embodiments of the present disclosure will be clearly and completely described below with reference to the accompanying drawings in the embodiments of the present disclosure, and it is apparent that the described embodiments are only a part of the embodiments of the present disclosure rather than all of the embodiments. All other embodiments obtained by a person of ordinary skill in the art based on the embodiments of the present disclosure without making creative efforts shall fall within the protection scope of the present disclosure.

The terminology used in the embodiments of the present disclosure is for the purpose of describing particular embodiments only and is not intended to limit the embodiments of the present disclosure. The singular forms “a” and “the” used in the embodiments of the present disclosure and the appended claims are also intended to include plural forms, unless the context clearly indicates other meanings. It will also be understood that the term “and/or” as used herein refers to and encompasses any and all possible combinations of one or more associated listed items.

It should be understood that although the terms “first”, “second”, “third”, etc., may be used to describe various information in the embodiments of the present disclosure, this information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on the context, the word “if” as used herein may be interpreted as “when” or “upon” or “in response to determining”.

For purposes of brevity and ease of understanding, the terms used herein when characterizing magnitude relationships are “greater than” or “less than”, “higher than”, or “lower than”. However, for a person skilled in the art, it may be understood that the term “greater than” also covers a meaning of “greater than or equal to”, and “less than” also covers a meaning of “less than or equal to”; the term “higher than” covers a meaning of “higher than or equal to”, and “lower than” also covers a meaning of “lower than or equal to”.

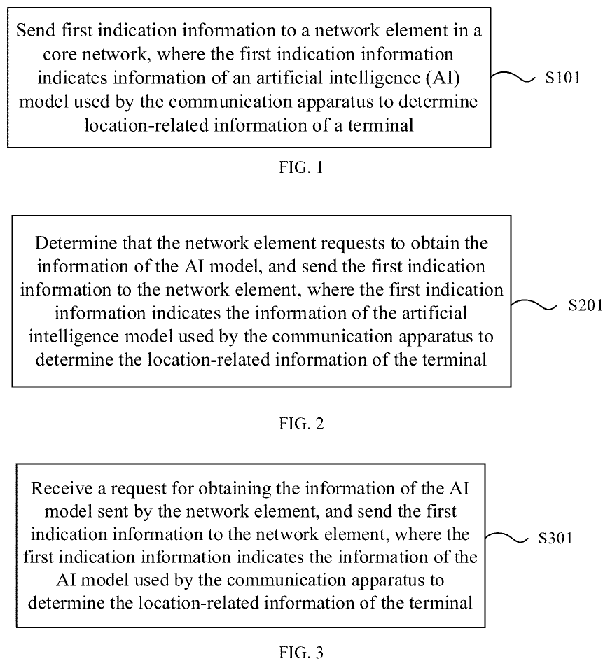

FIG. 1 is a schematic flowchart of an information sending method according to an embodiment of the present disclosure. The information sending method shown in this embodiment may be performed by a communication apparatus.

In an embodiment, the communication apparatus includes a terminal, the terminal may communicate with a network device, and the network device includes but is not limited to a network device in a communication system such as 4G, 5G, or 6G, for example, a base station, a core network, or a network element in a core network.

In an embodiment, the communication apparatus includes a base station, for example, a 5G base station gNB, and the base station may communicate with a terminal, or may communicate with a core network or a network element in a core network, where the core network includes but is not limited to a core network in a communication system such as 4G, 5G, or 6G.

As shown in FIG. 1, the information sending method may include a following step.

In step S101, sending first indication information to a network element in a core network, where the first indication information indicates information of an artificial intelligence (AI) model used by the communication apparatus to determine location-related information of a terminal.

In an embodiment, the communication apparatus may determine the location-related information of the terminal by using the artificial intelligence model. The communication apparatus may prestore a plurality of artificial intelligence models, which are respectively applicable to determining a plurality of types of location-related information in a plurality of positioning application scenarios.

In an embodiment, the positioning application scenario includes at least one of:
urban microcells (UMi); urban macrocells (UMa); indoor hotspot coverage-open hotspot coverage (indoor office-open office); indoor hotspot coverage-mixed hotspot coverage (indoor office-mixed office); indoor factory-sparse clutter and base station antenna lower than clutter (InF-SL (Sparse Clutter, Low BS)).

In an embodiment, for each positioning application scenario, a training sample set may be constructed separately, and learning is performed based on the training sample set to obtain an artificial intelligence model for determining location-related information in a corresponding scenario.

For example, for a UMi positioning application scenario, a UMi training sample set may be constructed, and then learning is performed based on the UMi training sample set to obtain an artificial intelligence model for determining location-related information in the UMi positioning application scenario.

For example, for a InF-SL positioning application scenario, a InF-SL training sample set may be constructed, and then learning is performed based on the InF-SL training sample set to obtain an artificial intelligence model for determining location-related information in the InF-SL positioning application scenario.

In an embodiment, the location-related information includes at least one of: a measurement result related to a positioning reference signal; or a location of the terminal.

In an embodiment, the measurement result related to the positioning reference signal includes at least one of: line of sight (LOS); non line of sight (NLOS); reference signal time difference (RSTD); reference signal receiving power (RSRP); or location.

The measurement result related to the positioning reference signal such as the line of sight, the non line of sight, the reference signal time difference, and the reference signal received power are intermediate data used to determine the location. The communication apparatus may select to use an artificial intelligence model to determine the location of the terminal, or may select to use an artificial intelligence model to determine one or more pieces of the intermediate data.

In an embodiment, for each type of location-related information, a training sample set may be constructed, and learning is performed based on the training sample set to obtain an artificial intelligence model for determining the corresponding location-related information.

For example, for RSTD, a RSTD training sample set may be constructed, and then learning is performed based on the RSTD training sample set to obtain an artificial intelligence model for determining RSTD.

For example, for RSRP, a RSRP training sample set may be constructed, and then learning is performed based on the RSRP training sample set to obtain an artificial intelligence model for determining RSRP.

In an embodiment, for a combination of each positioning application scenario and each piece of location-related information, a training sample set may be separately constructed, and learning is performed based on the training sample set to obtain an artificial intelligence model for determining corresponding location-related information in a corresponding positioning application scenario.

For example, for a UMi positioning application scenario and a RSTD, a UMi/RSTD training sample set may be constructed, and then learning is performed based on the UMi/RSTD training sample set to obtain an artificial intelligence model for determining the RSTD in the UMi positioning application scenario.

For example, for an InF-SL positioning application scenario and an RSTD, an InF-SL/RSTD training sample set may be constructed, and then learning is performed based on the InF-SL/RSTD training sample set to obtain an artificial intelligence model for determining the RSTD in the InF-SL positioning application scenario.

In an embodiment, a process of obtaining the artificial intelligence model may be implemented by the communication apparatus, or may be implemented by another apparatus to send the obtained artificial intelligence model to the communication apparatus.

Based on the above embodiments, considering that a plurality of types of location-related information need to be determined in a plurality of positioning application scenarios, the communication apparatus may store a plurality of artificial intelligence models.

According to the embodiments of the present disclosure, a communication apparatus can send first indication information to a network element of a core network, and the first indication information indicates an artificial intelligence model used by the communication apparatus to determine location-related information of a terminal, such that the network element of the core network can learn, in a timely manner, about the artificial intelligence model used by the communication apparatus, and thus can perform proper management on the artificial intelligence model.

In an embodiment, management on the artificial intelligence model includes at least one of: updating the artificial intelligence model; activating the artificial intelligence model; deactivating the artificial intelligence model; selecting the artificial intelligence model; and converting the artificial intelligence model.

In an embodiment, the information of the artificial intelligence model includes at least one of: an identifier of the AI model; a structure of the AI model; and a weight parameter of the AI model.

After determining the information of the adopted artificial intelligence model, the network element of the core network may further determine the artificial intelligence model based on the information of the artificial intelligence model. In addition, the network element in the core network may further receive a positioning result obtained by the communication apparatus based on the artificial intelligence model, that is, the location-related information of the terminal. By evaluating the positioning result, it can be determined whether the positioning result is accurate, and then it can be determined how to manage the artificial intelligence model according to an evaluation result.

For example, when the positioning result is inaccurate, the network element of the core network may instruct, based on the obtained artificial intelligence model information, the communication apparatus to update the artificial intelligence model; for example, the location-related information acquired by the communication apparatus through a first artificial intelligence model obtained by the core network element does not meet an expectation, the core network element may instruct the communication apparatus to deactivate the first artificial intelligence model, and activate a second artificial intelligence model.

In an embodiment, the network element includes a location management function (LMF).

In an embodiment, the communication apparatus includes at least one of: a terminal or a base station.

In an embodiment, when the communication apparatus is the terminal, the first indication information is carried in a long term evolution positioning protocol (LTE positioning protocol, LPP) message.

When the communication apparatus is the terminal, the terminal may send the LPP message to the LMF, and in this embodiment, the first indication information is carried in the LPP message, for example, carried in an LPP location information response message, so that the first indication information does not need to be separately sent, thereby saving communication resources.

In an embodiment, when the communication apparatus is the terminal, the first indication information is carried in a measurement result related to a positioning reference signal of the location-related information and/or a location of the terminal of the location-related information.

When the communication apparatus is the terminal, the terminal may determine the measurement result related to the positioning reference signal and send the measurement result to the network element, or may determine a location of the terminal and send the location of the terminal to the network element. In this embodiment, the terminal may report the first indication information to the network element together with the measurement result related to the positioning reference signal, or may report the first indication information to the network element together with the location of the terminal, thereby saving communication resources.

In an embodiment, when the communication apparatus is the base station, the first indication information is carried in a New Radio Positioning Protocol A (NRPPa) message.

When the communication apparatus is the base station, the base station may send the NRPPa message to the LMF, and in this embodiment, the first indication information is carried in the NRPPa message, for example, carried in a measurement report message in the NRPPa message, so that the first indication information does not need to be separately sent, thereby saving communication resources.

In an embodiment, when the communication apparatus is the base station, the first indication information is carried in a positioning reference signal-related measurement result of the location-related information.

When the communication apparatus is the base station, the base station may determine a measurement result related to the positioning reference signal and send the measurement result to the network element. In this embodiment, the base station may report the first indication information to the network element together with the measurement result related to the positioning reference signal, which helps save communication resources.

FIG. 2 is a schematic flowchart of another information sending method according to an embodiment of the present disclosure. As shown in FIG. 2, sending the first indication information to the network element of the core network includes a following step.

In step S201, determining that the network element requests to obtain the information of the AI model from the communication apparatus, and sending the first indication information to the network element.

In an embodiment, the communication apparatus may send the first indication information to the network element only when determining that the network element requests to obtain the information of the artificial intelligence model, to indicate the information of the artificial intelligence used by the communication apparatus to determine the location-related information of the terminal. When it is determined that the network element does not need to obtain the information of the artificial intelligence model, or when it is not determined whether the network element needs to obtain the information of the artificial intelligence model, the first indication information does not need to be sent to the network element. This helps avoid resource waste caused by sending the first indication information to the network element when the network element does not need to obtain the information of the artificial intelligence model.

FIG. 3 is a schematic flowchart of another information sending method according to an embodiment of the present disclosure. As shown in FIG. 3, determining that the network element requests to obtain the information of the AI model from the communication apparatus includes a following step.

In step S301, receiving a request for obtaining the information of the AI model sent by the network element.

In an embodiment, when receiving the request for obtaining the information of the artificial intelligence model sent by the network element, the communication apparatus may determine that the network element requests to obtain the information of the artificial intelligence model. In this case, the network element explicitly requests to obtain the information of the artificial intelligence model.

For example, when the communication apparatus is the terminal, the network element may carry the request for obtaining the information of the artificial intelligence model by using the LPP message, for example, the LPP location information request message, and send to the terminal, to request the terminal to report the information of the artificial intelligence model for determining the location-related information.

For example, when the communication apparatus is the base station, the network element may carry the request for obtaining the information of the artificial intelligence model by using the NRPPa message, for example, the measurement request message, and send to the base station, to request the base station to report the information of the artificial intelligence model for determining the measurement result of the positioning reference signal.

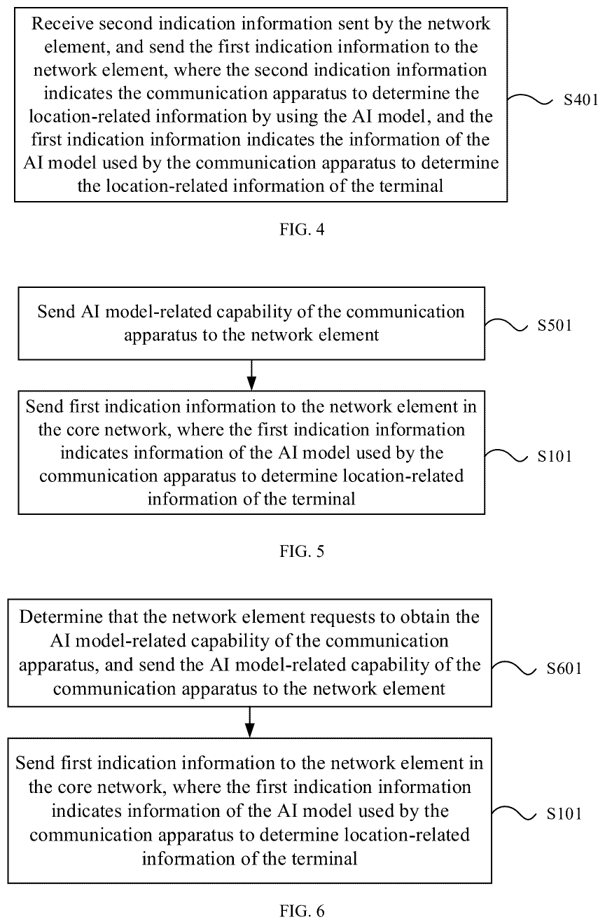

FIG. 4 is a schematic flowchart of another information sending method according to an embodiment of the present disclosure. As shown in FIG. 4, determining that the network element requests to obtain the information of the AI model from the communication apparatus includes a following step.

In step S401, receiving second indication information sent by the network element, where the second indication information indicates the communication apparatus to determine the location-related information by using the AI model.

In an embodiment, when receiving the second indication information sent by the network element, and determining, based on the second indication information, to use the artificial intelligence model to determine the location-related information, the communication apparatus may determine that the network element requests to obtain the information of the artificial intelligence model. In this case, the network element does not explicitly send a request to the terminal to obtain the information of the artificial intelligence model, but causes, by using the second indication information other than the request, the communication apparatus to determine that the network element requests to obtain the information of the artificial intelligence model.

For example, when the communication apparatus is the terminal, the network element may send the second indication information to the terminal by using an LPP message, for example, an LPP location information request message, to request the terminal to determine location-related information by using an artificial intelligence model, where the second indication information is used to request the terminal to determine the location-related information by using the artificial intelligence model.

For example, when the communication apparatus is the base station, the network element may send second indication information to the base station by using an NRPPa message, for example, an measurement request message, to request the base station to determine the measurement result related to the positioning reference signal by using the artificial intelligence model, where the second indication information is used to request the base station to determine the measurement result related to the positioning reference signal by using the artificial intelligence model.

FIG. 5 is a schematic flowchart of another information sending method according to an embodiment of the present disclosure. As shown in FIG. 5, the method further includes a following step.

In step S501, sending AI model-related capability of the communication apparatus to the network element, where the AI model-related capability includes at least one of:
whether sending the first indication information to the network element is supported;
supporting direct positioning based on the AI model, for example, the communication apparatus can obtain the location of the terminal based on the artificial intelligence model;
supporting indirect positioning based on the AI model, for example, the communication apparatus can obtain the intermediate data in related parameters of the location of the terminal based on the artificial intelligence model;
supporting at least one type of the location-related information determined based on the AI model;
respective AI model used to determine each of the at least one type of the location-related information; or
a parameter of the AI model.

In an embodiment, the terminal may send the artificial intelligence model-related capability to the network element, so that the network element may learn the artificial intelligence model-related capability, so that operations such as requesting to obtain information of the artificial intelligence model and managing the artificial intelligence model may be properly performed subsequently based on the artificial intelligence model-related capability.

For example, if the network element determines, based on the artificial intelligence model-related capability, that the at least one type of location-related information that is supported to be determined based on the artificial intelligence model by the communication apparatus includes the RSRP, the network element may subsequently send the second indication information to the communication apparatus, and indicate, by using the second indication information, the communication apparatus to determine the RSRP by using the artificial intelligence model. Therefore, it can be avoided that the communication apparatus is instructed to use the artificial intelligence model to determine the location-related information that is not supported to be determined by the communication apparatus based on the artificial intelligence model, thereby avoiding waste of communication resources.

In an embodiment, when the communication apparatus is the terminal, the terminal may carry the artificial intelligence model-related capability of the terminal in an LPP provide capability message and send to the network element of the core network.

In an embodiment, when the communication apparatus is the base station, the base station may carry the artificial intelligence model-related capability of the base station by using an NRPPa message, and send to the network element of the core network.

FIG. 6 is a schematic flowchart of another information sending method according to an embodiment of the present disclosure. As shown in FIG. 6, sending the artificial intelligence AI model-related capability of the communication apparatus to the network element includes a following step.

In step S601, determining that the network element requests to obtain the AI model-related capability of the communication apparatus, and sending the AI model-related capability of the communication apparatus to the network element.

In an embodiment, the communication apparatus may send the artificial intelligence model-related capability to the network element only when determining that the network element requests to obtain the artificial intelligence model-related capability. When it is determined that the network element does not need to obtain the artificial intelligence model-related capability, or when it is not determined whether the network element needs to obtain the artificial intelligence model-related capability, the artificial intelligence model-related capability does not need to be sent to the network element. This helps avoid resource waste caused by sending the artificial intelligence model-related capability to the network element when the network element does not need to obtain the artificial intelligence model-related capability.

In an embodiment, when the communication apparatus is the terminal, the network element in the core network may request, by using an LPP request capability message, to obtain the artificial intelligence model-related capability of the terminal.

In an embodiment, when the communication apparatus is the base station, the network element in the core network may request, by using an NRPPa message, to obtain the artificial intelligence model-related capability of the base station.

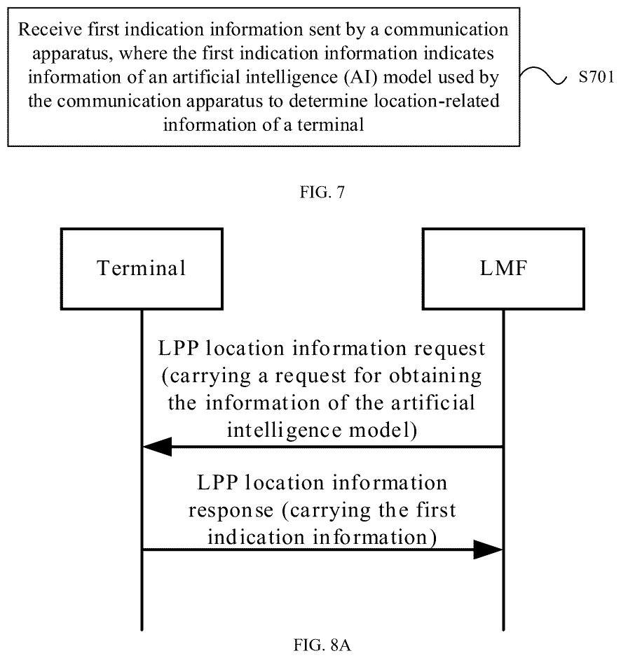

FIG. 7 is a schematic flowchart of an information receiving method according to an embodiment of the present disclosure. The information receiving method shown in this embodiment may be performed by a network element of a core network, the network element of the core network may communicate with a communication apparatus, the communication apparatus includes but is not limited to a terminal or a base station, and the core network includes but is not limited to a core network in a communication system such as a 4G base station, a 5G base station, or a 6G base station.

As shown in FIG. 7, the information receiving method may include a following step.

In step S701, receiving first indication information sent by a communication apparatus, where the first indication information indicates information of an artificial intelligence (AI) model used by the communication apparatus to determine location-related information of a terminal.

In an embodiment, the communication apparatus may determine the location-related information of the terminal by using the artificial intelligence model. The communication apparatus may prestore a plurality of artificial intelligence models, which are respectively applicable to determining a plurality of types of location-related information in a plurality of positioning application scenarios.

In an embodiment, the positioning application scenario includes at least one of:
urban microcells; urban macrocells; indoor hotspot coverage-open hotspot coverage; indoor hotspot coverage-mixed hotspot coverage; InF-SL (Sparse Clutter, Low BS).

In an embodiment, for each positioning application scenario, a training sample set may be constructed separately, and learning is performed based on the training sample set to obtain an artificial intelligence model for determining location-related information in a corresponding scenario.

For example, for a UMi positioning application scenario, a UMi training sample set may be constructed, and then learning is performed based on the UMi training sample set to obtain an artificial intelligence model for determining location-related information in the UMi positioning application scenario.

For example, for a InF-SL positioning application scenario, a InF-SL training sample set may be constructed, and then learning is performed based on the InF-SL training sample set to obtain an artificial intelligence model for determining location-related information in the InF-SL positioning application scenario.

In an embodiment, the location-related information includes at least one of: a measurement result related to a positioning reference signal; or a location of the terminal.

In an embodiment, the measurement result related to the positioning reference signal includes at least one of: line of sight (LOS); non line of sight (NLOS); reference signal time difference (RSTD); reference signal receiving power (RSRP); or location.

The measurement result related to the positioning reference signal such as the line of sight, the non line of sight, the reference signal time difference, and the reference signal received power are intermediate data used to determine the location. The communication apparatus may select to use an artificial intelligence model to determine the location of the terminal, or may select to use an artificial intelligence model to determine one or more pieces of the intermediate data.

In an embodiment, for each type of location-related information, a training sample set may be constructed, and learning is performed based on the training sample set to obtain an artificial intelligence model for determining the corresponding location-related information.

For example, for RSTD, a RSTD training sample set may be constructed, and then learning is performed based on the RSTD training sample set to obtain an artificial intelligence model for determining RSTD.

For example, for RSRP, a RSRP training sample set may be constructed, and then learning is performed based on the RSRP training sample set to obtain an artificial intelligence model for determining RSRP.

In an embodiment, for a combination of each positioning application scenario and each piece of location-related information, a training sample set may be separately constructed, and learning is performed based on the training sample set to obtain an artificial intelligence model for determining corresponding location-related information in a corresponding positioning application scenario.

For example, for a UMi positioning application scenario and a RSTD, a UMi/RSTD training sample set may be constructed, and then learning is performed based on the UMi/RSTD training sample set to obtain an artificial intelligence model for determining the RSTD in the UMi positioning application scenario.

For example, for an InF-SL positioning application scenario and an RSTD, an InF-SL/RSTD training sample set may be constructed, and then learning is performed based on the InF-SL/RSTD training sample set to obtain an artificial intelligence model for determining the RSTD in the InF-SL positioning application scenario.

In an embodiment, a process of obtaining the artificial intelligence model may be implemented by the communication apparatus, or may be implemented by another apparatus to send the obtained artificial intelligence model to the communication apparatus.

Based on the above embodiments, considering that a plurality of types of location-related information need to be determined in a plurality of positioning application scenarios, the communication apparatus may store a plurality of artificial intelligence models.

According to the embodiments of the present disclosure, a network element of a core network can receive first indication information sent by a communication apparatus, and determine an artificial intelligence model used by the communication apparatus to determine location-related information of a terminal, such that the network element of the core network can learn, in a timely manner, about the artificial intelligence model used by the communication apparatus, and thus can perform proper management on the artificial intelligence model.

In an embodiment, management on the artificial intelligence model includes at least one of: updating the artificial intelligence model; activating the artificial intelligence model; deactivating the artificial intelligence model; selecting the artificial intelligence model; and converting the artificial intelligence model.

In an embodiment, the information of the artificial intelligence model includes at least one of: an identifier of the AI model; a structure of the AI model; and a weight parameter of the AI model.

After determining the information of the adopted artificial intelligence model, the network element of the core network may further determine the artificial intelligence model based on the information of the artificial intelligence model. In addition, the network element in the core network may further receive a positioning result obtained by the communication apparatus based on the artificial intelligence model, that is, the location-related information of the terminal. By evaluating the positioning result, it can be determined whether the positioning result is accurate, and then it can be determined how to manage the artificial intelligence model according to an evaluation result.

For example, when the positioning result is inaccurate, the network element of the core network may instruct, based on the obtained artificial intelligence model information, the communication apparatus to update the artificial intelligence model; for example, the location-related information acquired by the communication apparatus through a first artificial intelligence model obtained by the core network element does not meet an expectation, the core network element may instruct the communication apparatus to deactivate the first artificial intelligence model, and activate a second artificial intelligence model.

In an embodiment, the network element includes a location management function (LMF).

In an embodiment, the communication apparatus includes at least one of: a terminal or a base station.

In an embodiment, when the communication apparatus is the terminal, the first indication information is carried in a long term evolution positioning protocol (LTE positioning protocol, LPP) message.

When the communication apparatus is the terminal, the LMF can receive the LPP message sent by the terminal, and in this embodiment, the first indication information is carried in the LPP message, for example, carried in an LPP location information response message, so that the first indication information does not need to be separately received, thereby saving communication resources.

In an embodiment, when the communication apparatus is the terminal, the first indication information is carried in a measurement result related to a positioning reference signal of the location-related information and/or a location of the terminal of the location-related information.

When the communication apparatus is the terminal, the terminal may determine the measurement result related to the positioning reference signal and send the measurement result to the network element, or may determine a location of the terminal and send the location of the terminal to the network element. In this embodiment, the terminal may report the first indication information to the network element together with the measurement result related to the positioning reference signal, or may report the first indication information to the network element together with the location of the terminal, thereby saving communication resources.

In an embodiment, when the communication apparatus is the base station, the first indication information is carried in a New Radio Positioning Protocol A (NRPPa) message.

When the communication apparatus is the base station, the LMF can receive the NRPPa message sent by the base station, and in this embodiment, the first indication information is carried in the NRPPa message, for example, carried in a measurement report message in the NRPPa message, so that the first indication information does not need to be separately received, thereby saving communication resources.

In an embodiment, when the communication apparatus is the base station, the first indication information is carried in a positioning reference signal-related measurement result of the location-related information.

When the communication apparatus is the base station, the base station may determine a measurement result related to the positioning reference signal and send the measurement result to the network element. In this embodiment, the base station may report the first indication information to the network element together with the measurement result related to the positioning reference signal, which helps save communication resources.

In an embodiment, the method further includes: requesting to obtain the information of the AI model.

When the network element needs to obtain the information of the artificial intelligence model, the network element may first request to obtain the information of the artificial intelligence model from the communication apparatus, so that the communication apparatus sends the first indication information to the network element only when determining that the network element requests to obtain the information of the artificial intelligence model, to indicate the artificial intelligence model used by the communication device to determine location-related information of the terminal.

Correspondingly, when the communication apparatus determines that the network element does not need to obtain the information of the artificial intelligence model, or does not determine whether the network element needs to obtain the information of the artificial intelligence model, the first indication information does not need to be sent to the network element. This helps avoid resource waste caused by sending the first indication information to the network element when the network element does not need to obtain the information of the artificial intelligence model.

In an embodiment, requesting to obtain the information of the AI model includes:
sending a request for obtaining the information of the AI model to the communication apparatus.

In an embodiment, the network element may request to obtain the information of the artificial intelligence model by sending a request for obtaining the information of the artificial intelligence model to the communication apparatus. In this case, the network element explicitly requests to obtain the information of the artificial intelligence model.

For example, when the communication apparatus is the terminal, the network element may carry the request for obtaining the information of the artificial intelligence model by using the LPP message, for example, the LPP location information request message, and send to the terminal, to request the terminal to report the information of the artificial intelligence model for determining the location-related information.

For example, when the communication apparatus is the base station, the network element may carry the request for obtaining the information of the artificial intelligence model by using the NRPPa message, for example, the measurement request message, and send to the base station, to request the base station to report the information of the artificial intelligence model for determining the measurement result of the positioning reference signal.

In an embodiment, requesting to obtain the information of the AI model includes:
sending second indication information to the communication apparatus, where the second indication information indicates the communication apparatus to determine the location-related information by using the AI model.

The network element may send the second indication information to the communication apparatus, to indicate, by using the second indication information, the communication apparatus to determine the location-related information by using the artificial intelligence model, to request to obtain the information of the artificial intelligence model. In this case, the network element does not explicitly send a request to the terminal to obtain the information of the artificial intelligence model, but causes, by using the second indication information other than the request, the communication apparatus to determine that the network element requests to obtain the information of the artificial intelligence model.

For example, when the communication apparatus is the terminal, the network element may send the second indication information to the terminal by using an LPP message, for example, an LPP location information request message, to request the terminal to determine location-related information by using an artificial intelligence model, where the second indication information is used to request the terminal to determine the location-related information by using the artificial intelligence model.

For example, when the communication apparatus is the base station, the network element may send second indication information to the base station by using an NRPPa message, for example, an measurement request message, to request the base station to determine the measurement result related to the positioning reference signal by using the artificial intelligence model, where the second indication information is used to request the base station to determine the measurement result related to the positioning reference signal by using the artificial intelligence model.

In an embodiment, the method further includes: receiving AI model-related capability of the communication apparatus sent by the communication apparatus, where the AI model-related capability includes at least one of:
whether sending the first indication information to the network element is supported;
supporting direct positioning based on the AI model;
supporting indirect positioning based on the AI model;
supporting at least one type of the location-related information determined based on the AI model;
respective AI model used to determine each of the at least one type of the location-related information; or
a parameter of the AI model.

In an embodiment, the network element may learn the artificial intelligence model-related capability by receiving the artificial intelligence model-related capability sent by the communication apparatus, so that operations such as requesting to obtain information of the artificial intelligence model and managing the artificial intelligence model may be properly performed subsequently based on the artificial intelligence model-related capability.

For example, if the network element determines, based on the artificial intelligence model-related capability, that the at least one type of location-related information that is supported to be determined based on the artificial intelligence model by the communication apparatus includes the RSRP, the network element may subsequently send the second indication information to the communication apparatus, and indicate, by using the second indication information, the communication apparatus to determine the RSRP by using the artificial intelligence model. Therefore, it can be avoided that the communication apparatus is instructed to use the artificial intelligence model to determine the location-related information that is not supported to be determined by the communication apparatus based on the artificial intelligence model, thereby avoiding waste of communication resources.

In an embodiment, when the communication apparatus is the terminal, the terminal may carry the artificial intelligence model-related capability of the terminal in an LPP provide capability message and send to the network element of the core network, and correspondingly, the network element can obtain the artificial intelligence model-related capability of the terminal from the LPP provide capability message.

In an embodiment, when the communication apparatus is the base station, the base station may carry the artificial intelligence model-related capability of the base station by using an NRPPa message, and send to the network element of the core network, and correspondingly, the network element can obtain the artificial intelligence model-related capability of the base station from the NRPPa message.

In an embodiment, the method further includes: requesting to obtain the AI model-related capability of the communication apparatus.

When the network element needs to obtain the artificial intelligence model-related capability, the network element may first request to obtain the artificial intelligence model-related capability from the communication apparatus, so that the communication apparatus may send the artificial intelligence model-related capability to the network element only when determining that the network element requests to obtain the artificial intelligence model-related capability.

Correspondingly, when the communication apparatus determines that the network element does not need to obtain the artificial intelligence model-related capability, or when the communication apparatus does not determine whether the network element needs to obtain the artificial intelligence model-related capability, the artificial intelligence model-related capability does not need to be sent to the network element. This helps avoid resource waste caused by sending the artificial intelligence model-related capability to the network element when the network element does not need to obtain the artificial intelligence model-related capability.

In an embodiment, when the communication apparatus is the terminal, the network element in the core network may request, by using an LPP request capability message, to obtain the artificial intelligence model-related capability of the terminal.

In an embodiment, when the communication apparatus is the base station, the network element in the core network may request, by using an NRPPa message, to obtain the artificial intelligence model-related capability of the base station.

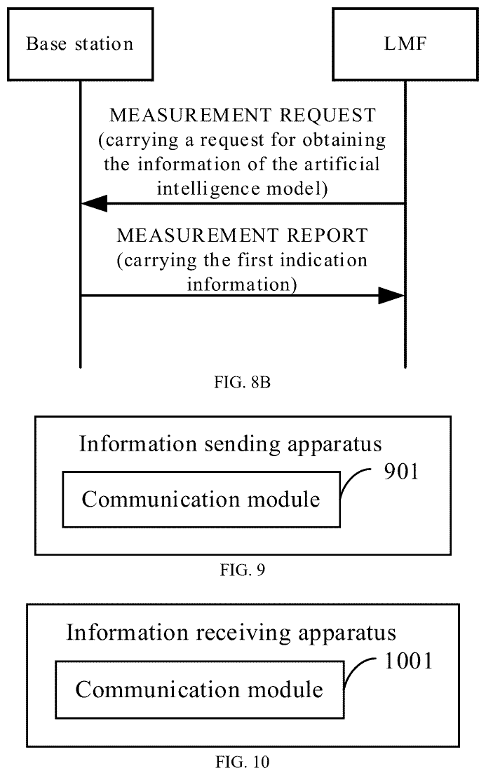

FIG. 8A is a schematic diagram of interaction between a terminal and a network element according to an embodiment of the present disclosure.

As shown in FIG. 8A, an example is provided where the communication apparatus is the terminal and the network element is the LMF.

The terminal may send the first indication information to the LMF, where the first indication information is used to indicate information of the AI model used by the terminal to determine the location-related information of the terminal, for example, the first indication information is carried in an LPP location information response message and sent to the LMF. After receiving the first indication information, the LMF may learn of the artificial intelligence model used by the terminal to determine the location related information of the terminal itself.

The LMF may first send an LPP location information request message carrying a request for obtaining the information of the artificial intelligence model to the terminal. The terminal sends the first indication information to the LMF only after receiving the request for obtaining the information of the artificial intelligence model.

Optionally, the LMF may first send second indication information to the terminal, where the second indication information indicates the terminal to determine the location-related information by using the artificial intelligence model. After receiving the second indication information, the terminal may determine that the LMF requests to obtain the information of the artificial intelligence model, and then send the first indication information to the LMF.

FIG. 8B is a schematic diagram of interaction between a base station and a network element according to an embodiment of the present disclosure.

As shown in FIG. 8B, an example is provided where the communication apparatus is the base station and the network element is the LMF.

The base station may send the first indication information to the LMF, where the first indication information indicates information of the AI model used by the base station to determine the location-related information of the terminal, for example, the first indication information is carried in a MEASUREMENT REPORT message in the NRPPa message and sent to the LMF. After receiving the first indication information, the LMF may learn of the artificial intelligence model used by the base station to determine the location-related information of the terminal.

The LMF may first send the MEASUREMENT REQUEST message to the base station, where the MEASUREMENT REQUEST message carries a request for obtaining the information of the artificial intelligence model. The base station sends the first indication information to the LMF only after receiving the request for obtaining the information of the artificial intelligence model.

Optionally, the LMF may first send second indication information to the base station, where the second indication information indicates the base station to determine the location-related information by using the artificial intelligence model. After receiving the second indication information, the base station may determine that the LMF requests to obtain the information of the artificial intelligence model, and then send the first indication information to the LMF.

An embodiment of the present disclosure further provides an information transceiving system, including a communication apparatus and a network element of a core network, where the communication apparatus is configured to implement the information sending method according to any one of the above embodiments, and the network element is configured to implement the information receiving method according to any one of the above embodiments.

For other specific content related to interaction between the communication apparatus and the network element, reference may be made to the above information sending method embodiments and/or information receiving method embodiments, and details will not be repeated herein.

Corresponding to the above embodiments of the information sending method and the information receiving method, the present disclosure further provides embodiments of an information sending apparatus and an information receiving apparatus.

FIG. 9 is a schematic block diagram of an information sending apparatus according to an embodiment of the present disclosure. As shown in FIG. 9, the apparatus includes:
a communication module 901, configured to send first indication information to a network element in a core network, where the first indication information indicates information of an artificial intelligence (AI) model used by a communication apparatus to determine location-related information of a terminal.

In an embodiment, the network element includes a location management function (LMF).

In an embodiment, the communication apparatus includes at least one of: a terminal or a base station.

In an embodiment, when the communication apparatus is the terminal, the first indication information is carried in a long term evolution positioning protocol (LTE positioning protocol, LPP) message.

In an embodiment, when the communication apparatus is the terminal, the first indication information is carried in a measurement result related to a positioning reference signal of the location-related information and/or a location of the terminal of the location-related information.

In an embodiment, when the communication apparatus is the base station, the first indication information is carried in a New Radio Positioning Protocol A (NRPPa) message.

In an embodiment, when the communication apparatus is the base station, the first indication information is carried in a positioning reference signal-related measurement result of the location-related information.

In an embodiment, the communication module is configured to determine that the network element requests to obtain the information of the artificial intelligence model, and send the first indication information to the network element.

In an embodiment, the communication module is configured to receive a request for obtaining the information of the artificial intelligence model sent by the network element.

In an embodiment, the communication module is configured to receive second indication information sent by the network element, where the second indication information is used to indicate the communication apparatus to determine the location-related information by using the artificial intelligence model.

In an embodiment, the communication module is further configured to send an artificial intelligence model-related capability of the communication apparatus to the network element, where the artificial intelligence model-related capability includes at least one of:
whether sending the first indication information to the network element is supported;
supporting direct positioning based on the AI model;
supporting indirect positioning based on the AI model;
supporting at least one type of the location-related information determined based on the AI model;
respective AI model used to determine each of the at least one type of the location-related information; or
a parameter of the AI model.

In an embodiment, the communication module is configured to determine that the network element requests to obtain the artificial intelligence model-related capability of the communication apparatus, and send the artificial intelligence model-related capability of the communication apparatus to the network element.

In an embodiment, the location-related information includes at least one of: a measurement result related to a positioning reference signal; or a location of the terminal.

In an embodiment, the measurement result related to the positioning reference signal includes at least one of: line of sight (LOS); non line of sight (NLOS); reference signal time difference (RSTD); reference signal receiving power (RSRP); or location.

In an embodiment, the information of the artificial intelligence model includes at least one of: an identifier of the AI model; a structure of the AI model; and a weight parameter of the AI model.

FIG. 10 is a schematic block diagram of an information receiving apparatus according to an embodiment of the present disclosure. As shown in FIG. 10, the apparatus includes:
a communication module 1001, configured to receive first indication information sent by a communication apparatus, where the first indication information indicates information of an artificial intelligence (AI) model used by the communication apparatus to determine location-related information of a terminal.

In an embodiment, the network element includes a location management function (LMF).

In an embodiment, the communication apparatus includes at least one of: a terminal or a base station.

In an embodiment, when the communication apparatus is the terminal, the first indication information is carried in a long term evolution positioning protocol (LTE positioning protocol, LPP) message.

In an embodiment, when the communication apparatus is the terminal, the first indication information is carried in a measurement result related to a positioning reference signal of the location-related information and/or a location of the terminal of the location-related information.

In an embodiment, when the communication apparatus is the base station, the first indication information is carried in a New Radio Positioning Protocol A (NRPPa) message.

In an embodiment, when the communication apparatus is the base station, the first indication information is carried in a positioning reference signal-related measurement result of the location-related information.

In an embodiment, the communication module is further configured to request to obtain the information of the artificial intelligence model.

In an embodiment, the communication module is configured to send a request for obtaining the information of the artificial intelligence model to the communication apparatus.

In an embodiment, the communication module is configured to send second indication information to the communication apparatus, where the second indication information is used to indicate the communication apparatus to determine the location-related information by using the artificial intelligence model.

In an embodiment, the communication module is further configured to receive an artificial intelligence model-related capability of the communication apparatus sent by the communication apparatus, where the artificial intelligence model-related capability includes at least one of:
whether sending the first indication information to the network element is supported;
supporting direct positioning based on the AI model;
supporting indirect positioning based on the AI model;
supporting at least one type of the location-related information determined based on the AI model;
respective AI model used to determine each of the at least one type of the location-related information; or
a parameter of the AI model.

In an embodiment, the communication module is further configured to request to obtain the artificial intelligence model-related capability of the communication apparatus.

In an embodiment, the location-related information includes at least one of: a measurement result related to a positioning reference signal; or a location of the terminal.

In an embodiment, the measurement result related to the positioning reference signal includes at least one of: line of sight (LOS); non line of sight (NLOS); reference signal time difference (RSTD); reference signal receiving power (RSRP); or location.

In an embodiment, the information of the artificial intelligence model includes at least one of: an identifier of the AI model; a structure of the AI model; and a weight parameter of the AI model.

For the apparatus in the above embodiments, the specific manner in which each module performs operations has been described in detail in the embodiments of the related methods, and will not be repeated in detail here.

For the apparatus embodiments, as they basically correspond to the method embodiments, relevant parts can be referred from the description of the method embodiments. The apparatus embodiments described above are merely illustrative, where the modules described as separate components may or may not be physically separated, and the components displayed as modules may or may not be physical modules, that is, may be located in one place, or may be distributed on a plurality of network modules. Some or all of the modules may be selected according to actual needs to achieve the objectives of the solutions of the present embodiments. A person of ordinary skill in the art may understand and implement the embodiments of the present disclosure without making creative efforts.

An embodiment of the present disclosure further provides a communication apparatus, including: a processor; and a memory configured to store a computer program, where when the computer program is executed by the processor, the information receiving method according to any one of the above embodiments is implemented.

An embodiment of the present disclosure further provides a communication apparatus, including: a processor; and a memory configured to store a computer program, where when the computer program is executed by the processor, the information sending method according to any one of the above embodiments is implemented.

An embodiment of the present disclosure further provides a computer-readable storage medium, configured to store a computer program, where when the computer program is executed by a processor, the information sending method according to any one of the above embodiments is implemented.

An embodiment of the present disclosure further provides a computer-readable storage medium, configured to store a computer program, where when the computer program is executed by a processor, the information receiving method according to any one of the above embodiments is implemented.

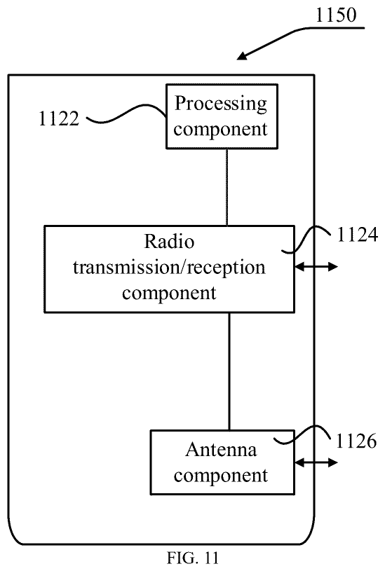

As shown in FIG. 11, FIG. 11 is a schematic block diagram of a device 1100 for receiving information according to an embodiment of the present disclosure. The device 1100 may be provided as a base station. Referring to FIG. 11, the device 1100 includes a processing component 1122, a radio transmission/reception component 1124, an antenna component 1126, and a signal processing portion specific to a radio interface, and the processing component 1122 may further include one or more processors. One of the processors in the processing component 1122 may be configured to implement the information receiving method described in any of the above embodiments.

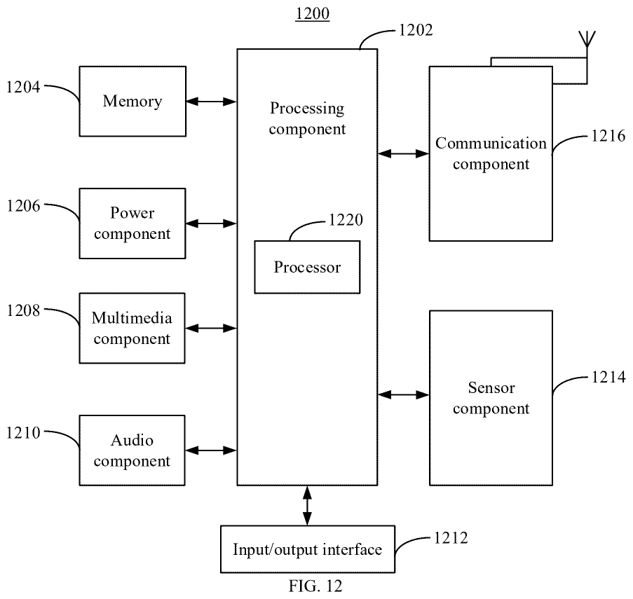

FIG. 12 is a schematic block diagram of a device 1200 for receiving information according to an embodiment of the present disclosure. For example, the apparatus 1200 may be a mobile phone, a computer, a digital broadcast terminal, a messaging device, a gaming console, a tablet device, a medical device, exercise equipment, a personal digital assistant, etc.

Referring to FIG. 12, the device 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 typically controls overall operations of the device 1200, such as the operations associated with display, telephone calls, data communications, camera operations, and recording operations. The processing component 1202 may include one or more processors 1220 to execute instructions to perform all or part of the steps in the above information receiving method. Moreover, the processing component 1202 may include one or more modules which facilitate the interaction between the processing component 1202 and other components. For example, the processing component 1202 may include a multimedia module to facilitate the interaction between the multimedia component 1208 and the processing component 1202.

The memory 1204 is configured to store various types of data to support the operation of the device 1200. Examples of such data include instructions for any applications or methods operated on the device 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the device 1200. The power component 1206 may include a power management system, one or more power sources, and any other components associated with the generation, management, and distribution of power in the device 1200.

The multimedia component 1208 includes a screen providing an output interface between the device 1200 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 1208 includes a front camera and/or a rear camera. The front camera and the rear camera may receive an external multimedia datum while the device 1200 is in an operation mode, such as a photographing mode or a video mode. Each of the front camera and the rear camera may be a fixed optical lens system or have focal length and optical zoom capability.

The audio component 1210 is configured to output and/or input audio signals. For example, the audio component 1210 includes a microphone (MIC) configured to receive an external audio signal when the device 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. These buttons may include, but are not limited to, home buttons, volume buttons, start buttons, and lock buttons.

The sensor component 1214 includes one or more sensors to provide status assessments of various aspects of the device 1200. For instance, the sensor component 1214 may detect an open/closed status of the device 1200, relative positioning of components, e.g., the display and the keypad, of the device 1200, a change in position of the device 1200 or a component of the device 1200, a presence or absence of user contact with the device 1200, an orientation or an acceleration/deceleration of the device 1200, and a change in temperature of the device 1200. The sensor component 1214 may include a proximity sensor configured to detect the presence of nearby objects without requiring any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the device 1200 and other devices. The device 1200 may access a wireless network based on a communication standard, such as WiFi, 2G, 3G, 4G LTE, 5G NR or a combination thereof. In an example embodiment, the communication component 1216 receives a broadcast signal or broadcast associated information from an external broadcast management system via a broadcast channel. In an example embodiment, the communication component 1216 further includes a near field communication (NFC) module to facilitate short-range communications. For example, NFC modules may be implemented based on radio frequency identification (RFID) technology, infrared data association (IrDA) technology, ultra-wideband (UWB) technology, Bluetooth (BT) technology, and other technologies.

In an example embodiment, the device 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above information receiving method.

In an example embodiment, there is also provided a non-transitory computer-readable storage medium including instructions, such as included in the memory 1204, executable by the processor 1220 in the device 1200, for performing the above information receiving method. For example, the non-transitory computer-readable storage medium may be a ROM (read-only memory), a RAM (random access memory), CD-ROM (compact disc read-only memory), magnetic tape, floppy disk, optical data storage device, or the like.

Other embodiments of the present disclosure will be apparent to those skilled in the art from consideration of the specification and practice of the present disclosure disclosed herein. The present disclosure is intended to cover any variations, uses, or adaptations of the present disclosure following the general principles thereof and including such departures from the present disclosure as come within known or customary practice in the art. It is intended that the specification and examples be considered as examples only, with a true scope and spirit of the disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

It should be noted that, in this specification, relational terms such as “first” and “second” are merely used to distinguish one entity or operation from another entity or operation, and do not necessarily require or imply that there is any such actual relationship or order between these entities or operations. The terms “include”, “comprise” or any other variations thereof are intended to cover non-exclusive inclusion, so that a process, method, article or device that includes a series of elements includes not only those elements, but also other elements that are not explicitly listed, or elements inherent to such a process, method, article or device. An element proceeded by “includes a . . . ” does not, without more constraints, preclude the existence of additional identical elements in the process, method, article, or device that includes the element.

The method and device provided by the embodiments of the present disclosure are described in detail above, specific examples are used herein to describe the principles and implementations of the present disclosure, and the description of the above embodiments is only used to help understand the method and core idea of the present disclosure; meanwhile, for those skilled in the art, according to the idea of the present disclosure, there will be changes in the specific implementations and application scope, and in summary, the content of the present specification should not be construed as limiting the present disclosure.

1. An information sending method, performed by a communication apparatus, comprising:
sending first indication information to a network element in a core network, wherein the first indication information indicates information of an artificial intelligence (AI) model used by the communication apparatus to determine location-related information of a terminal.

2. The method according to claim 1, wherein the network element comprises:
a location management function (LMF).

3. The method according to claim 1, wherein the communication apparatus comprises at least one of:
the terminal; or
a base station.

4. The method according to claim 3, wherein when the communication apparatus is the terminal, the first indication information is carried in a long-term evolution positioning protocol (LPP) message.

5. The method according to claim 3, wherein when the communication apparatus is the terminal, the first indication information is carried in at least one of a measurement result related to a positioning reference signal of the location-related information, or a location of the terminal of the location-related information.

6. The method according to claim 3, wherein when the communication apparatus is the base station, the first indication information is carried in a New Radio Positioning Protocol A (NRPPa) message.

7. The method according to claim 3, wherein when the communication apparatus is the base station, the first indication information is carried in a measurement result related to a positioning reference signal of the location-related information.

8. The method according to claim 1, wherein sending the first indication information to the network element in the core network comprises:
determining that the network element requests to obtain the information of the Al model from the communication apparatus, and sending the first indication information to the network element.

9. The method according to claim 8, wherein determining that the network element requests to obtain the information of the AI model from the communication apparatus comprises:
receiving a request for obtaining the information of the AI model sent by the network element.

10. The method according to claim 8, wherein determining that the network element requests to obtain the information of the AI model from the communication apparatus comprises:
receiving second indication information sent by the network element, wherein the second indication information indicates the communication apparatus to determine the location-related information by using the AI model.

11. The method according to claim 1, further comprising:
sending AI model-related capability of the communication apparatus to the network element, wherein the Al model-related capability comprises at least one of:
whether sending the first indication information to the network element is supported;
supporting direct positioning based on the AI model;
supporting indirect positioning based on the AI model;
supporting at least one type of the location-related information determined based on the AI model;
respective AI model used to determine each of the at least one type of the location-related information; or
a parameter of the AI model;
wherein sending the AI model-related capability of the communication apparatus to the network element comprises:
determining that the network element requests to obtain the AI model-related capability of the communication apparatus, and sending the AI model-related capability of the communication apparatus to the network element.

12. (canceled)

13. The method according to claim 1, wherein the location-related information comprises at least one of: a measurement result related to a positioning reference signal, or a location of the terminal;
wherein the information of the AI model comprises at least one of:
an identifier of the AI model;
a structure of the AI model; or
a weight parameter of the AI model.

14. (canceled)

15. An information receiving method, performed by a network element of a core network, comprising:
receiving first indication information sent by a communication apparatus, wherein the first indication information indicates information of an artificial intelligence (AI) model used by the communication apparatus to determine location-related information of a terminal.

16. The method according to claim 15, wherein the network element comprises:
a location management function (LMF);
wherein the communication apparatus comprises at least one of:
the terminal; or
a base station;
wherein when the communication apparatus is the terminal, the first indication information is carried in a long-term evolution positioning protocol (LPP) message, or in at least one of a measurement result related to a positioning reference signal of the location-related information, or a location of the terminal of the location-related information;
wherein when the communication apparatus is the base station, the first indication information is carried in a New Radio Positioning Protocol A (NRPPa) message, or in a measurement result related to a positioning reference signal of the location-related information.

17.-21. (canceled)

22. The method according to claim 15, further comprising:
requesting to obtain the information of the AI model,
wherein requesting to obtain the information of the AI model comprises:
sending a request for obtaining the information of the AI model to the communication apparatus; or
sending second indication information to the communication apparatus, wherein the second indication information indicates the communication apparatus to determine the location-related information by using the AI model.

23. (canceled)

24. (canceled)

25. The method according to claim 15, further comprising:
receiving AI model-related capability of the communication apparatus sent by the communication apparatus, wherein the Al model-related capability comprises at least one of:
whether sending the first indication information to the network element is supported;
supporting direct positioning based on the AI model;
supporting indirect positioning based on the AI model;
supporting at least one type of the location-related information determined based on the AI model;
respective AI model used to determine each of the at least one type of the location-related information; or
a parameter of the AI model;
wherein the method further comprises:
requesting to obtain the AI model-related capability of the communication apparatus.

26. (canceled)

27. The method according to claim 15, wherein the location-related information comprises at least one of:
a measurement result related to a positioning reference signal; or a location of the terminal;
wherein the information of the AI model comprises at least one of:
an identifier of the AI model;
a structure of the AI model; or
a weight parameter of the AI model.

28.-30. (canceled)

31. An information transceiving system, comprising:
a communication apparatus; and
a network element of a core network,
wherein the communication apparatus is configured to:
send first indication information to the network element in the core network, wherein the first indication information indicates information of an artificial intelligence (AI) model used by the communication apparatus to determine location-related information of a terminal; and
the network element is configured to perform the information receiving method according to claim 15.

32. A communication device, comprising:
a processor; and
a memory for storing a computer program;
wherein the processor is configured to perform the information sending method according to claim 1.

33. (canceled)

34. A communication device, comprising:
a processor; and
a memory for storing a computer program;
wherein the processor is configured to perform the information receiving method according to claim 15.
